(19) United States
(12) Patent Application Publication
(10) Pub. No.: US 2026/0206033 A1
(43) Pub. Date: Jul. 16, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Jing Wang, Beijing, Haidian District (CN); Lan Chen, Beijing, Haidian District (CN)

(73) Assignee: NTT DOCOMO, INC., Tokyo (JP)

(21) Appl. No.: 19/135,261

(22) PCT Filed: Dec. 15, 2022
(86) PCT No.: PCT/JP2022/046189

§ 371 Date: Jun. 3, 2025

(51) Int. Cl. H04W 72/231; H04W 76/19

(52) U.S. Cl. CPC H04W 72/231; H04W 76/19

(57) ABSTRACT

A terminal according to one aspect of the present disclosure includes a receiving section that receives a MAC CE (MAC Control Element) including cell switching indication information on cell switching from a serving cell to a candidate cell, and a control section that controls, based on the cell switching indication information, a configuration of a window or a timer for switching from the serving cell to the candidate cell, and operation after the cell switching. The control section controls the window or the timer, based on a MAC reset configuration indicating the operation after the cell switching.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (Non-Patent Literature 1). In addition, for the purpose of further high capacity, advancement and the like of LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

It is assumed that, in future radio communication systems (for example, radio communication systems of Rel. 16/5G or later), communication is controlled based on inter-cell mobility with a plurality of cells including a non-serving cell or inter-cell mobility using a plurality of transmission/reception points (for example, multi-TRP (MTRP)).

However, in a case of applying the inter-cell mobility, how to control UL transmission (for example, control of timing advance, switching of a cell, and the like) is a problem. Unless the inter-cell mobility can be performed appropriately, communication quality may deteriorate.

The present disclosure has been made in view of this respect, and an object of the present disclosure is to provide a terminal, a radio communication method, and a base station that can appropriately control communication even when inter-cell mobility is performed.

### Solution to Problem

A terminal according to one aspect of the present disclosure includes a receiving section that receives a MAC CE (MAC Control Element) including cell switching indication information on cell switching from a serving cell to a candidate cell, and a control section that controls, based on the cell switching indication information, a configuration of a window or a timer for switching from the serving cell to the candidate cell, and operation after the cell switching. The control section controls the window or the timer, based on a MAC reset configuration indicating the operation after the cell switching.

### Advantageous Effects of Invention

According to one aspect of the present disclosure, communication can be appropriately controlled even when inter-cell mobility is performed.

### BRIEF DESCRIPTION OF DRAWINGS

FIG. 1A and FIG. 1B are diagrams to show examples of inter-cell mobility.

FIG. 2 is a diagram to show examples of switching between a serving cell and an additional cell by L1/L2 signaling.

FIG. 3 is a diagram to show an example of configuration examples 1 to 3 when candidate cells are supported.

FIG. 4A to FIG. 4C are diagrams to show examples of respective cases where switching with candidate cells/a candidate cell group by L1/L2 signaling is performed in configuration examples 1 to 3 when candidate cells are supported,

FIG. 5 is a diagram to show an example of timing advance groups (TAGs) to which cells included in a cell group belong.

FIG. 6 is a diagram to show an example of a MAC CE for timing advance command.

FIGS. 7A and 7B are diagrams to show examples of TAG IDS configured for a serving cell and a candidate cell.

FIG. 8 is a diagram to show an example of a case of success of L1/L2 inter-cell mobility.

FIG. 9 is a diagram to show another example of the case of success of L1/L2 inter-cell mobility.

FIG. 10 is a diagram to show an example of a case of failure of L1/L2 inter-cell mobility.

FIG. 11 is a diagram to show another example of the case of failure of L1/L2 inter-cell mobility.

FIGS. 12A and 12B are diagrams to show examples of a start timing of a new window/timer according to a second embodiment.

FIG. 13 is a diagram to show another example of the start timing of the new window/timer according to the second embodiment.

FIG. 14 is a diagram to show an example of a stop timing of a new window/timer according to a third embodiment.

FIG. 15 is a diagram to show another example of the stop timing of the new window/timer according to the third embodiment.

FIG. 16 is a diagram to show an example of a schematic structure of a radio communication system according to one embodiment.

FIG. 17 is a diagram to show an example of a structure of a base station according to one embodiment.

FIG. 18 is a diagram to show an example of a structure of a user terminal according to one embodiment.

FIG. 19 is a diagram to show an example of a hardware structure of the base station and the user terminal according to one embodiment.

FIG. 20 is a diagram to show an example of a vehicle according to one embodiment.

### DESCRIPTION OF EMBODIMENTS

### (TCI, Spatial Relation, QCL)

For NR, control of reception processing (for example, at least one of reception, de-mapping, demodulation, and decoding) and transmission processing (for example, at least one of transmission, mapping, precoding, modulation, and coding) of at least one of a signal and a channel (referred to as a signal/channel) in a UE, based on a transmission configuration indication state (TCI state) has been under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

Note that a channel/signal being a target of application of a TCI state may be referred to as a target channel/reference signal (RS) or simply as a target, and another signal described above may be referred to as a reference reference signal (reference RS), a source RS, or simply as a reference.

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), a reference signal for QCL detection (also referred to as a QRS), a reference signal for demodulation (DeModulation Reference Signal (DMRS)), and the like.

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

### (Inter-Cell Mobility)

For NR, it is studied that one or a plurality of transmission/reception points (TRPs) (multi-TRP (MTRP)) perform DL transmission to a UE. It is also studied that the UE performs UL transmission to the one or plurality of TRPs.

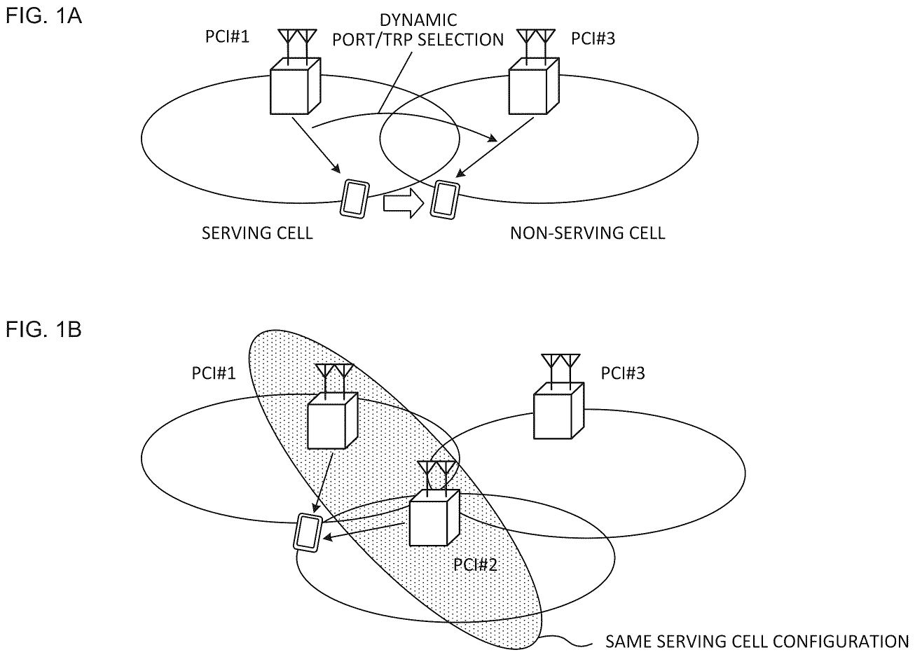

It is considered that a UE receives channels/signals from a plurality of cells/TRPs in inter-cell mobility (for example, L1/L2 inter cell mobility) (see FIGS. 1A and 1B).

FIG. 1A shows an example of inter-cell mobility with cells including a non-serving cell (for example, Single-TRP inter-cell mobility). A UE may be configured with one TRP (or a single TRP) in each cell. Here, shown is a case where the UE receives channels/signals from a base station/TRP of cell #1 being a serving cell, and a base station/TRP of cell #3 being not a serving cell (non-serving cell). For example, this corresponds to a case where the UE switches from cell #1 to cell #3 (for example, fast cell switch).

In this case, selection of a port (for example, an antenna port)/TRP or may be performed dynamically. The selection of a port (for example, an antenna port)/TRP or may be performed based on a TCI state indicated or updated by DCI/MAC CE. Here, shown is a case of supporting configuration of different physical cell IDs (for example, PCIs) for cell #1 and cell #3.

FIG. 1B shows an example of a multi-TRP scenario (for example, inter-cell mobility in a case of using multi-TRP (Multi-TRP inter-cell mobility)). A UE may be configured with a plurality of (for example, two) TRPs (or different CORESET pool indices) in each cell. Here, shown is a case where the UE receives channels/signals from TRP #1 and TRP 2. Here, also shown is a case where TRP #1 corresponds to physical cell ID (PCI) #1 and TRP #2 corresponds to PCI #2.

The multi-TRP (for example, TRPs #1 and #2) may be connected via ideal/non-ideal backhaul to exchange information, data, and the like. Each TRP of the multi-TRP may transmit the same or a different codeword (Code Word (CW)) and the same or a different layer. As one mode of multi-TRP transmission, non-coherent joint transmission (NCJT) may be employed as shown in FIG. 1B. Here, shown is a case where NCJT is performed between TRPs corresponding to different PCIs. Note that the same serving cell configuration may be applied/configured for TRP #1 and TRP #2.

It may be defined that a plurality of PDSCHs (multi-PDSCH) subjected to NCJT partially or completely overlap with respect to at least one of time and frequency domains. In other words, a first PDSCH from TRP #1 and a second PDSCH from TRP #2 may overlap in terms of at least one of time and frequency resources. The first PDSCH and the second PDSCH may be used for transmission of the same TB or may be used for transmission of different TBs.

The first PDSCH and the second PDSCH may be may be assumed not to be in a quasi-co-location (QCL) relationship (not to be quasi-co-located). Reception of the multi-PDSCH may be interpreted as simultaneous reception of PDSCHs of a QCL type other than a certain QCL type (for example, QCL type D).

A plurality of PDSCHs (which may be referred to as multi-PDSCH (multiple PDSCHs)) from the multi-TRP may be scheduled by using one piece of DCI (single DCI (S-DCI, single PDCCH)) (single-master mode). The one piece of DCI may be transmitted from one TRP of the multi-TRP. A structure using one piece of DCI in multi-TRP may be referred to as single-DCI based multi-TRP (mTRP/MTRP).

The plurality of PDSCHs from the multi-TRP may be scheduled by using a plurality of respective pieces of DCI (multi-DCI (M-DCI), multi-PDCCH (multiple PDCCHs)). The plurality of pieces of DCI may be transmitted from respective TRPs of the multi-TRP. A structure using a plurality of pieces of DCI in multi-TRP may be referred to as multi-DCI based multi-TRP (mTRP/MTRP).

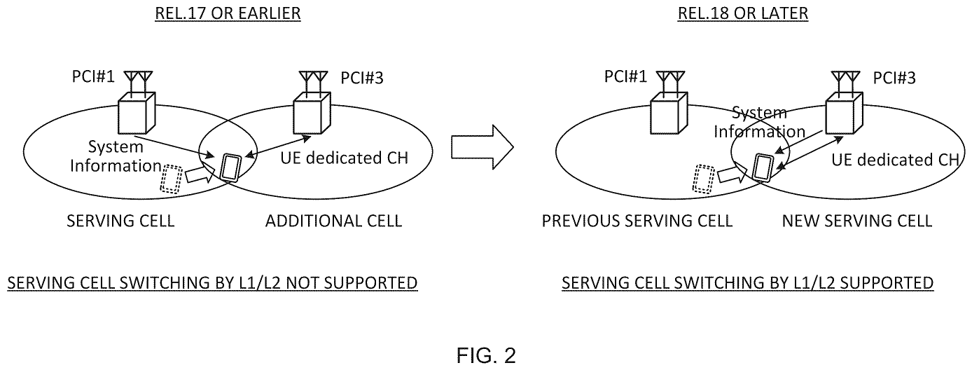

The UE may assume to transmit, to the different TRPS, separate CSI reports related to the respective TRPs. Such CSI feedback may be referred to as separate feedback, separate CSI feedback, and the like. In the present disclosure, “separate” may be interchangeably interpreted as “independent.” In Rel-17 NR, it is assumed that beam indication to TCI states associated with different PCIs by a MAC CE/DCI is supported. Meanwhile, in Rel-18 NR or later versions, it is assumed that serving cell switching (for example, indication of change of a serving cell to a cell having a different PCI) by L1/L2 signaling (for example, DCI/MAC CE) is supported (see FIG. 2).

FIG. 2 shows a case where the UE performs, based on cell switching indication from the base station, cell switching from a serving cell to an additional cell (also referred to as a candidate cell or a target cell).

### (Candidate Cell)

It is also assumed that, in inter-cell mobility, one or a plurality of candidate cells are configured/managed for each serving cell.

For example, one or more candidate cells with information being restricted (for example, a UE is notified only of one or some of parameters) may be configured in a certain higher layer parameter (for example, ServingCellConfig) (Alt. 1). This may be configured similarly to inter-cell beam management (inter-cell BM) for existing systems (for example, Rel. 17).

Alternatively, a complete configuration (for example, ServingCellConfig) of one or more candidate cells may be configured, and the candidate cell(s) may be associated with each serving cell (Alt. 2). For example, a framework for carrier aggregation configuration (for example, CA configuration framework) or a framework for CHO (Conditional Handover)/CPC (Conditional PSCell Change) configuration may be reused.

In Alt. 1/2, activation/deactivation of a candidate cell(s) may be controlled by a MAC CE/DCI.

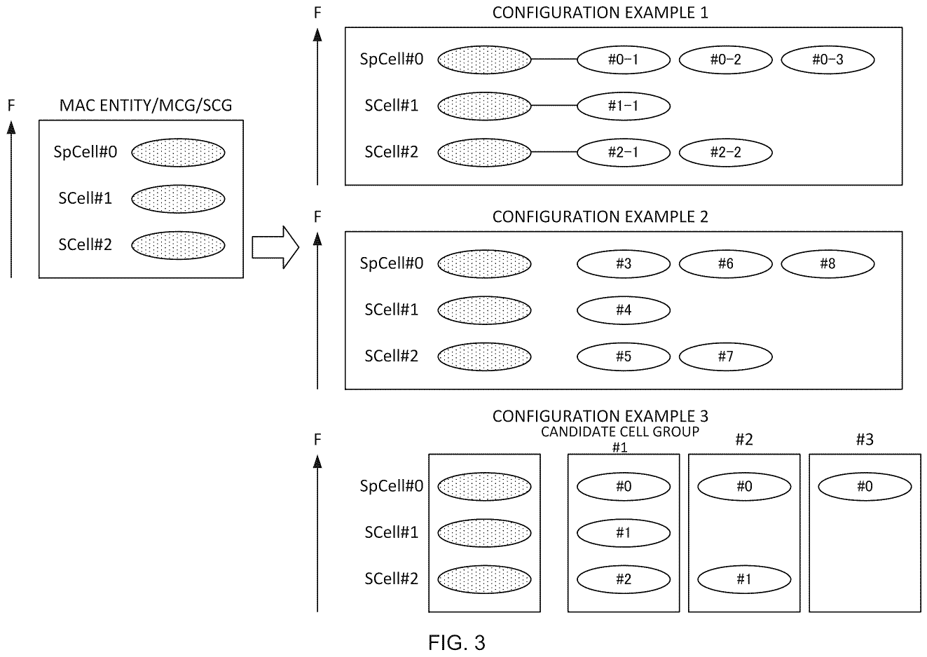

As configuration of candidate cells, at least one of configuration example 1 to configuration example 3 below may be used (see FIG. 3). Here, shown are examples of configuration/association of candidate cells (or additional cells) for serving cells/cell group when SpCell #0, SCell #1, and SCell #2 are configured as the serving cells. Configuration example 1 to configuration example 3 below are examples, and the number of cells, association for each cell, and the like are not limited to these and may be changed appropriately. Alternatively, another configuration example(s) may be supported/employed in addition to/instead of configuration example 1 to configuration example 3.

Configuration example 1 shows a case where one or more candidate cells are associated with/configured for each serving cell (see FIG. 3). Specifically, shown is a case where candidate cells #0-1, #0-2, and #0-3 are associated with SpCell #0, candidate cell #1-1 is associated with SCell #1, and candidate cells #2-1 and #2-2 are associated with SCell #2. Information related to this association may be configured for/indicated to a UE by a base station by RRC/MAC CE/DCI.

Configuration example 2 shows a case where candidate cells are associated with/configured for a MAC entity/MCG/SCG (see FIG. 3). Specifically, shown is a case where candidate cells #3 to #8 are associated with the MAC entity/MCG/SCG. In this case, instead of a candidate cell(s) being associated with each serving cell, the candidate cells are configured for the MAC entity or cell group (for example, an MCG/SCG). Information related to a candidate cell(s) to be configured for each cell may be configured for/indicated to a UE by a base station by RRC/MAC CE/DCI.

In configuration example 3, one or more candidate cell groups may be configured (see FIG. 3). Specifically, shown is a case where candidate cell group #1 including candidate cells #0 to #2, candidate cell group #2 including candidate cells #0 and #1, and candidate cell group #3 including candidate cell #0 are configured. Each candidate cell group includes one or more candidate cells. Each candidate cell included in the candidate cell group may be associated with at least one serving cell. Information related to the candidate cell(s) may be configured for/indicated to a UE by a base station by RRC/MAC CE/DCI.

In existing systems (for example, Rel. 17), L1 beam indication for a TCI state related to an additional PCI (or an additional cell) (for example, indication by a TCI state field of DCI) is supported.

It is assumed, in Rel. 18 or later versions, that a new L1/L2 signal (for example, DCI/MAC CE) indicating switching of a serving cell (for example, serving cell switch) is supported. It is assumed that, as the indication, at least one of implicit indication and explicit indication is supported. The implicit indication may mean that a certain CORESET is updated to a TCI state associated with an additional PCI by a MAC CE, for example. The explicit indication may mean that cell switching is directly indicated by DCI/MAC CE.

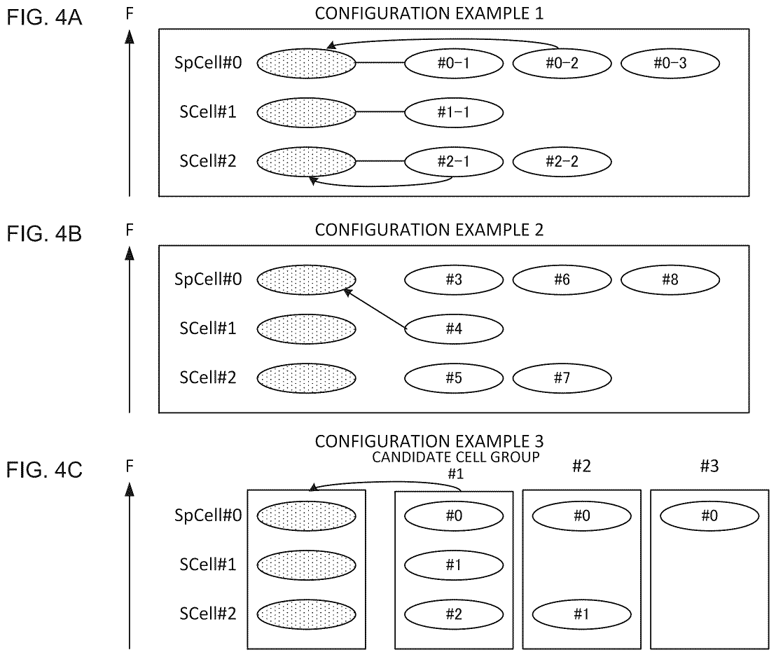

For example, in configuration example 1 of candidate cells, a certain candidate cell may be specified as a serving cell (or indicated for switching with a serving cell) via L1/L2 signaling. FIG. 4A shows a case where candidate cell #0-2 turns to be an SpCell of the MCG/SCG (SpCell #0 and candidate cell #0-2 are switched) by L1/L2 signaling. Also shown is a case where candidate cell #2-1 turns to be an SCell of an MCG/SCG (SCell #2 and candidate cell #2-1 are switched) by L1/L2 signaling.

Alternatively, in configuration example 2 of candidate cells, a certain candidate cell may be specified as a serving cell (or indicated for switching with a serving cell) via L1/L2 signaling. FIG. 4B shows a case where candidate cell #4 turns to be an SpCell of an MCG/SCG (SpCell #0 and candidate cell #4 are switched) by L1/L2 signaling.

Alternatively, in configuration example 3 of candidate cells, a certain candidate cell group (or one or more candidate cells included in the certain candidate cell group) may be changed/updated to a serving cell group via L1/L2 signaling. FIG. 4C shows a case where candidate cell group #1 (or candidate cells #0 to #2 included in candidate cell group #1) turns to be a serving cell group (or the serving cell group and candidate cell group #1 are switched) by L1/L2 signaling.

### (Timing Advance Group)

When a plurality of TRPs are used, there are some cases where the distance between a UE and each TRP is different. The plurality of TRPs may be included in the same cell (for example, a serving cell). Alternatively, among the plurality of TRPS, a certain TRP corresponds to the serving cell, while the other TRP(s) may correspond to a non-serving cell(s). In this case, it is also assumed that the distance between each TRP and the UE is different.

In existing systems, transmission timing of a UL (Uplink) channel and/or a UL signal (UL channel/signal) is adjusted by timing advance (TA). Reception timing of a UL channel/signal from a different user terminal (UE) is adjusted on the radio base station (also referred to as a TRP (Transmission and Reception Point), gNB (gNodeB), and the like)) side.

A UE may employ timing advance for each timing advance group (TAG) (multiple timing advances) configured in advance to perform timing control for UL transmission.

When the multiple timing advances is employed, timing advance groups (TAGs) classified according to transmission timing are supported. The UE may control UL transmission timing in each TAG by assuming that the same TA offset (or TA value) is used for each TAG. In other words, the TA offset may be configured independently for each TAG.

When the multiple timing advances are employed, the UE independently adjusting transmission timing for the cells belonging to each TAG enables matching at a radio base station in terms of timing of uplink signal reception from the UE even when a plurality of cells are used.

A TAG (for example, serving cells belonging to the same TAG) may be configured by a higher layer parameter. The same timing advance value may be applied to the serving cells belonging to the same TAG (for example, serving cells configured with UL). A timing advance group including an SpCell of a MAC entity may be referred to as a primary timing advance group (PTAG), and a TAG other than the PTAG may be referred to as a secondary timing advance group (STAG). The maximum number of TAGs may be X (for example, X=4) for each cell group (MCG/SCG).

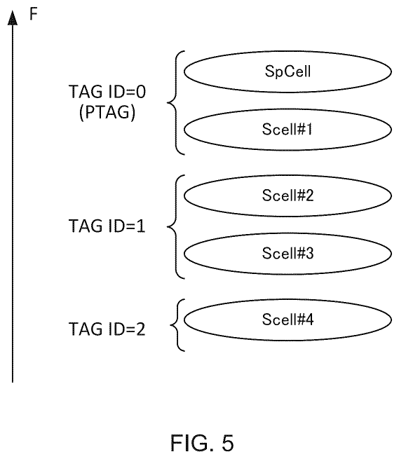

In existing systems (for example, Rel-16 NR), configuration of four TAGs at maximum (for example, MCG/SCG) is supported for each cell group (see FIG. 5), FIG. 5 shows a case where three TAGs are configured for a cell group including an SpCell and SCells #1 to #4. Here, shown is a case where the SpCell and SCell #1 belong to a first TAG (PTAG or TAG #0), SCell #2 and SCell #3 belong to a second TAG (TAG #1), and SCell #4 belongs to a third TAG (TAG #2).

A UE may be notified of a timing advance command (TA command) by using a MAC control element (for example, a MAC CE). The TA command is a command that indicates an uplink channel transmission timing value and is included in the MAC control element. The TA command is signaled from a radio base station to the UE on a MAC layer. The UE controls a certain timer (for example, a TA timer), based on reception of the TA command.

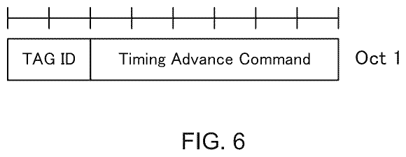

A MAC CE for timing advance command may have a structure including a field for timing advance group index (for example, TAG ID) and a field for timing advance command (see FIG. 6). The TAG ID field is used for indication of the TAG ID of an addressed TAG. The timing advance command field may indicate an index value T_{A} (0, 1, 2, . . . , 63) to be used for control of the amount of timing adjustment to be applied by the MAC entity.

A parameter corresponding to each TAG ID may be configured by a higher layer parameter. For example, a parameter such as a time alignment timer (for example, timeAlignmentTimer) corresponding to each TAG ID may be configured. Alternatively, a TAG ID may be configured for each serving cell by a higher layer parameter (for example, tag-ID included in ServingCellConfig). Note that each TAG ID/parameter may be updated by a MAC CE after being configured by a higher layer parameter.

The time alignment timer may be maintained for UL time alignment. In Rel. 17, a time alignment timer may be configured/associated for each TAG. When the UE has received a MAC CE for timing advance command (for example, a TAC MAC CE), the UE starts or restarts a time alignment timer related to each indicated timing advance group (for example, TAG).

When a MAC entity receives the TAC MAC CE, and a certain value (N_{TA}) is maintained for the indicated TAG, the MAC entity uses the timing advance command for the indicated TAG or starts or restarts the time alignment timer related to the indicated TAG. The certain value (N_{TA}) may be timing advance between DL and UL.

Operation when the time alignment timer expires may be defined separately for a PTAG and an STAG. Note that a timing advance group (TAG) including an SpCell of a MAC entity may be referred to as a primary timing advance group (PTAG), and a TAG other than the PTAG may be referred to as a secondary timing advance group (STAG).

For example, in Rel. 17, certain operation for PTAG is employed when a timing advance timer corresponding to a PTAG expires, and certain operation for STAG may be employed when a timing advance timer for STAG expires.

For example, when such a time alignment timer expires, the following operation (for example, the certain operation for PTAG/certain operation for STAG) may be performed.

### {Certain Operation for PTAG}

In a case where the time alignment timer is associated with a PTAG,
flush all the HARQ buffers of all serving cells.
notify RRC of release of a PUCCH, if configured, for all the serving cells.
notify RRC of release of an SRS, if configured.
clear all configured DL assignments and configured UL assignments.
clear a PUSCH resource for semi-persistent CSI reporting,
cause all running time alignment timers to expire.
maintain N_{TA} of all TAGS.

### {Certain Operation for STAG}

In a case where the time alignment timer is associated with an STAG, for all serving cells belonging to the TAG,
flush all HARQ buffers.
notify RRC of release of a PUCCH, if configured.
notify RRC of release of an SRS, if configured.
clear all configured DL assignments and UL assignments.
clear a PUSCH resource for semi-persistent CSI reporting.
maintain NA of the TAG.

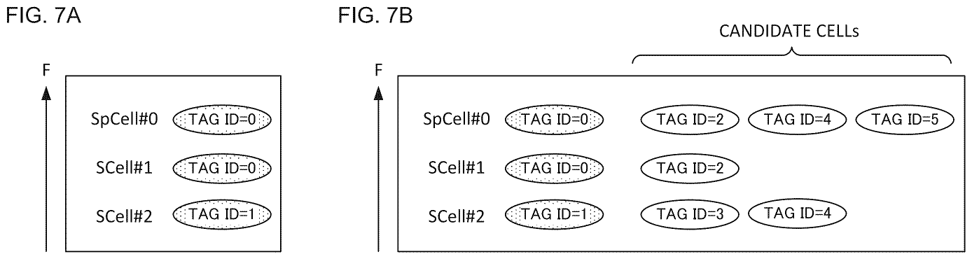

As described above, when candidate cells are configured/defined, it is assumed that each candidate cell is associated with a TAG (see FIGS. 7A and B). FIGS. 7A and 7B show an example of a TAG (or TAG ID configuration) for each cell group in an existing system (for example, Rel. 17 (or earlier versions)) and an example of TAG ID configuration for each candidate cell, respectively.

When candidate cells are configured/applied/supported, it is assumed that different serving cells/different candidate cells are associated with the same TAG, as described in FIG. 7B.

When a T_{A} for candidate cells is acquired, a RACH (or random access procedure) for the candidate cells may be supported.

### (Success/Failure of Inter-Cell Mobility (Cell Switching))

An example of UE operation/base station operation in a case of reception of a cell switching indication (or after the reception) (an example of success/failure of cell switching) will be described.

The base station may configure, for the UE, information related to configuration of a plurality of candidate cells by using higher layer signaling. The higher layer signaling may be RRC reconfiguration signaling, a cell-related higher layer parameter, or another higher layer parameter.

The base station may indicate, for the UE, serving cell change or switching by using a MAC CE/DCI. The UE performs cell switch procedure/switch operation, based on cell switching indication indicated by the MAC CE/DCI. The cell switching indication may be referred to as cell switch indication signaling or L1/L2 inter-cell mobility indication.

The MAC CE/DCI may include at least one of information related to a candidate cell to be a switch destination (for example, a candidate cell index or a physical cell ID (PCI)), information related to a serving cell to be a switch source, and information related to another candidate cell.

In the present disclosure, the serving cell change may be interpreted as serving cell switching or L1/L2 cell switch. In the present disclosure, indication of the serving cell change may be interpreted as activation/enabling of serving cell change.

The UE may, when serving cell change is indicated, assume that L1/L2 inter-cell mobility is configured to be enabled.

When receiving information indicating serving cell change (or change to a candidate cell), the UE may change a serving cell configuration to a target cell (or candidate cell), based on a cell configuration configured beforehand by a higher layer parameter. The UE may receive a DL transmission from the target cell by assuming a new beam/TCI state/spatial relation. Information related to the new beam/TCI state/spatial relation may be configured/indicated beforehand for the UE from the base station by using a higher layer parameter (for example, a higher layer parameter related to a candidate cell).

When the information related to the new beam/TCI state/spatial relation is not configured/indicated, the UE may assume a certain beam/TCI state/spatial relation. The certain beam/TCI state/spatial relation may be determined based on PRACH transmission in the target cell (or candidate cell). For example, the UE may judge/assume the certain beam/TCI state/spatial relation, based on the latest PRACH transmission associated with an SSB of the target cell.

When detecting a MAC CE/DCI indicating change of a serving cell (or change to a candidate cell), the UE may change, after a certain period, the serving cell to a serving cell configured by RRC configuration for a cell to be updated (for example, RRC configuration for a candidate cell). In the present disclosure, the certain period may be interpreted as a certain offset.

The certain period may be X ms or X symbols after the detected MAC CE/DCI. Alternatively, the certain period may be Y ms/Y symbols after HARQ-ACK feedback for the detected MAC CE/DCI. X and Y may be determined based on a UE capability/UE type, may be defined in a specification, or may be configured for the UE, from the base station.

Thus, it is conceivable that, in a case of success of cell switching (for example, L1/L2 inter-cell mobility), transmission/reception operation is controlled with a target cell serving as a serving cell. In this case, success/failure of the cell switching may be defined as follows. Options 1A-1 to 1A-3 and options 1B-1 to 1B-2 describe examples of success of cell switching (for example, L1/L2 inter-cell mobility) and examples of failure of cell switching (for example, L1/L2 inter-cell mobility), respectively.

### {Option 1A-1}

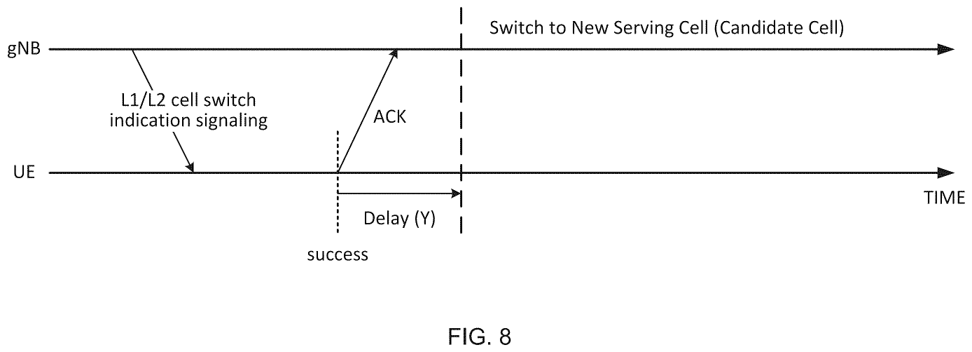

A HARQ-ACK being transmitted by the UE for serving cell switching indication may mean success of cell switching, which may allow UE operation/base station operation to be controlled. The HARQ-ACK may mean an ACK (ACKnowledgement) (see FIG. 8) or an ACK/NACK.

FIG. 8 shows a case where the base station transmits a serving cell switching indication (for example, L1/L2 cell switch indication signaling) to the UE and where an ACK being transmitted by the UE for the switching indication means success of cell switching. This case shows a case where switching to a new serving cell is controlled after a certain period (for example, Y) after success of cell switching (for example, after ACK transmission).

When the HARQ-ACK means an ACK, a NACK being transmitted by the UE (before transmission of the ACK) may not mean success of cell switching. In other words, before transmission of the ACK, NACK feedback or retransmission of L1/L2 signaling may be present.

For example, when a MAC CE indicates a serving cell switching indication, a case where HARQ-ACK feedback for a PDSCH for transmitting the MAC CE is an ACK may allow success of serving cell switching to be defined.

When DCI indicates a serving cell switching indication, definition of an ACK may differ depending on whether the DCI includes DL assignment/UL assignment.

When DCI including DL assignment is used for a serving cell switching indication, a case where HARQ-ACK feedback for a PDSCH scheduled by the DCI is an ACK may allow success of serving cell switching to be defined.

When DCI not including DL assignment/UL assignment is used for a serving cell switching indication, a case where HARQ-ACK feedback for the DCI (or a PDCCH for transmitting the DCI) is an ACK may allow success of serving cell switching to be defined. In this case, a CRC to be added to the DCI may be scrambled by a certain RNTI (for example, an RNTI other than a C-RNTI).

When DCI including UL assignment is used for a serving cell switching indication, a PUSCH scheduled by the DCI may be regarded as HARQ-ACK feedback including an ACK. In other words, feedback of the PUSCH may allow success of serving cell switching to be defined. Alternatively, a case where the base station reschedules a PUSCH having the same HPN (same HPN with a toggled NDI) may allow success of serving cell switching to be defined.

### {Option 1A-2}

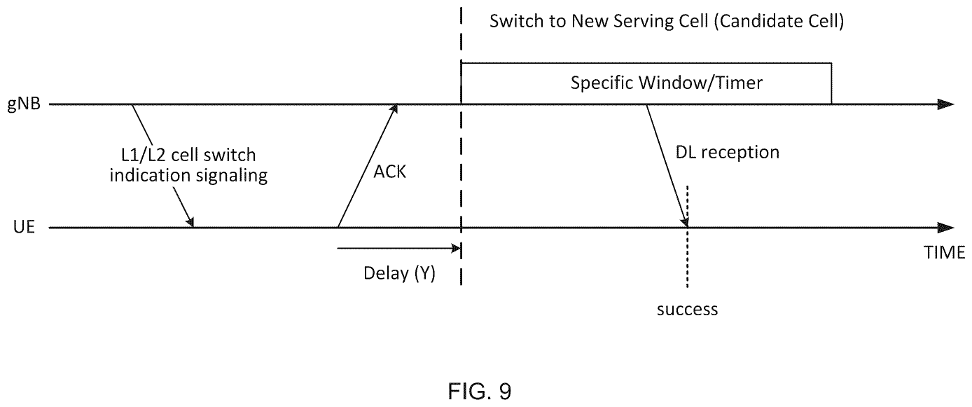

A case where the UE receives, in a specific window/timer (for example, a certain window/timer), a DL from a new target cell (or a candidate cell to be a change destination) may mean success of cell switching, which may allow UE operation/base station operation to be controlled (see FIG. 9). The DL received by the UE may be interpreted as at least one of a DL transmission, a DL signal, and a DL channel.

For example, the specific window/timer may be started after transmission of a HARQ-ACK (for example, an ACK) for a serving cell switching indication or after a lapse of a certain period (for example, Y) from the transmission of the HARQ-ACK. Of course, the start time of the specific window/timer is not limited to this. The specific window/timer (for example, at least one of a start time (start slot, start symbol, or the like) and a length) may be defined in a specification, or may be configured/indicated for the UE, from the base station, by using an RRC parameter/MAC CE/DCI.

The DL received by the UE may be at least one of options 1A-2-1 to 1A-2-3 below.

### <<Option 1A-2-1>>

The DL received by the UE may be a DL reference signal (for example, a DL-RS). For example, a case where the UE receives (or measures) a DL reference signal transmitted from the new target cell may mean success of serving cell switching. The DL reference signal may be at least one of an SSB, a CSI-RS, and a source RS of an indicated TCI state transmitted from the new target cell.

### <<Option 1A-2-2>>

The DL received by the UE may be a DL channel (for example, a PDCCH/PDSCH) or downlink control information (for example, DCI). For example, a case where the UE receives (or decodes/detects/monitors) a DL channel/DCI transmitted from the new target cell may mean success of serving cell switching. The DL channel (for example, the PDCCH/PDSCH) or the DCI may be a PDCCH/PDSCH corresponding to a certain format/type.

For example, a case where the UE receives DCI in a common search space (for example, a CSS) may mean success of serving cell switching.

Alternatively, a case where the UE receives a PDCCH/PDSCH having the same HARQ process ID as previous L1/L2 cell switch signaling may mean success of serving cell switching. The previous L1/L2 cell switch signaling may include a toggled NDI (assumption that there is no MAC reset).

### <<Option 1A-2-3>>

The DL received by the UE may be an explicit indication for confirmation (or activation, enabling) of serving cell switching. The explicit indication may be, for example, an RRC parameter/MAC CE/DCI corresponding to the explicit indication.

In at least one of options 1A-2-1 to 1A-2-3, RACH transmission (or RACH procedure) for the new target cell may be ended before cell switching, and a TA for the new target cell may be acquired before the cell switching.

### {Option 1A-3}

A case where the UE completes, in a specific window/timer (for example, a certain window/timer), random access procedure (or RACH procedure) for a new target cell (or a candidate cell to be a change destination) may mean success of cell switching, which may allow UE operation/base station operation to be controlled.

In option 1A-3, before the cell switching, RACH transmission (or RACH procedure) for the new target cell may not be performed or a T_{A} for the new target cell may not be acquired. In this case, the UE may perform the RACH procedure after performing switching to a new serving cell.

### {Option 1B-1}

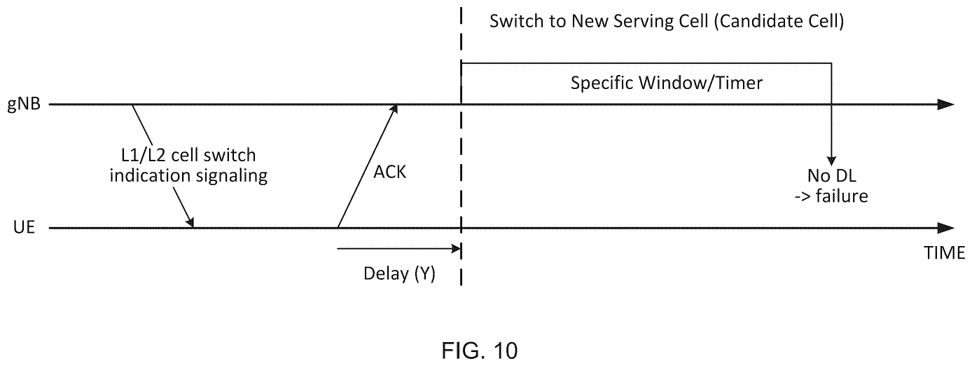

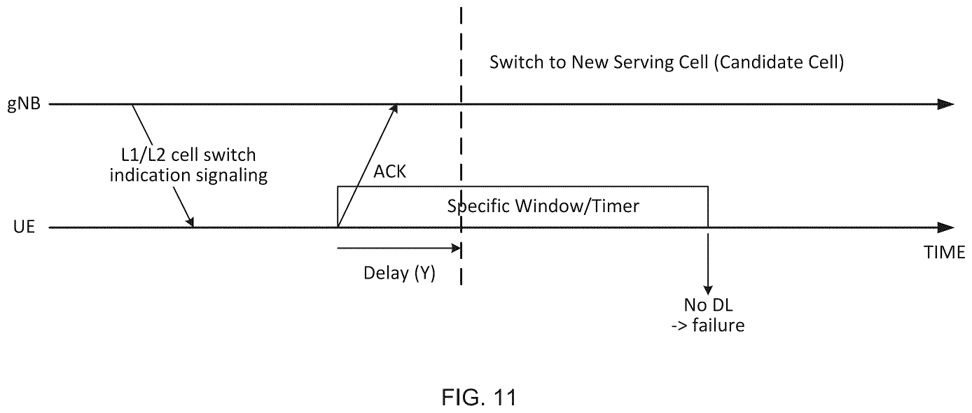

Failure to receive a certain DL before an end/expiration of a specific window/timer (or within the specific window/timer) (after the UE transmits a HARQ-ACK (for example, an ACK) for a serving cell switching indication or after the UE applies switching to a new target cell) may mean failure of cell switching (see FIGS. 10 and 11). The specific window/timer and the certain DL may be the window/timer and the DL described in option 1A-2.

FIG. 10 shows failure to receive the certain DL before the end/expiration of the specific window/timer (or within the specific window/timer) after the UE transmits a HARQ-ACK (for example, an ACK) for a serving cell switching indication. FIG. 11 shows failure to receive the certain DL before the end/expiration of the specific window/timer (or within the specific window/timer) after the UE applies switching to a new target cell. In FIG. 11, for example, the specific window/timer may be started, for example, at a timing of (immediately after/simultaneously with) transmission of a HARQ-ACK (for example, an ACK) for a serving cell switching indication.

In this case, the UE may declare/notify/report failure of cell switching (for example, L1/L2 inter-cell mobility) or occurrence of cell switch (for example, L1/L2 inter-cell mobility) failure.

A period (for example, a start time/length or the like) of the specific window/timer may be configured for the UE, from the base station, by using an RRC parameter, or may be included in a MAC CE/DCI indicating cell switching and indicated for the UE, from the base station. The start time may be a start slot or a start symbol.

### {Option 1B-2}

A case where the UE fails to complete random access procedure (or RACH procedure) for a new target cell before an end/expiration of a specific window/timer (or within the specific window/timer) may mean failure of cell switching. In this case, the UE may declare/notify/report failure of cell switching (for example, L1/L2 inter-cell mobility) or occurrence of cell switch (for example, L1/L2 inter-cell mobility) failure.

In the case of failure of cell switching (for example, option 1B-1 or option 1B-2), the UE may apply UE operation described in at least one of options 1C-1 to 1C-3 below.

### <<Option 1C-1>>

The UE may return to an original serving cell (for example, a serving cell as a switch source), and may apply the last TCI state in the cell and monitor DL transmission (for example, a PDCCH).

When the UE fails to receive the DL (option 1B-1) or fails to complete the RACH procedure (option 1B-2) within the specific window/timer after transmitting a HARQ-ACK (for example, an ACK) for a serving cell switching indication, at least the transmission of the ACK has succeeded. In this case, channel quality in the original serving cell is satisfactory, and there is a possibility that communication (for example, DL reception) can be performed appropriately.

### <<Option 1C-2>>

The UE may perform RACH transmission (or random access procedure) for a specific cell (for example, a certain cell). The specific cell may be at least one of an original serving cell (for example, a serving cell as a switch source) and a new target cell. For example, random access procedure in a case of radio link failure (RLF) may be reused.

### <<Option 1C-3>>

The UE may perform RACH transmission (or random access procedure) for any cell (for example, any cell). For example, random access procedure performed by the UE in an idle state (UE in IDLE) may be reused.

A UE capability for different UE operations after cell switch (for example, L1/L2 inter-cell mobility) failure may be introduced.

### (MAC Reconfiguration/MAC Reset)

As described above, it has been proposed that information related to a cell switching indication is transmitted to the UE from the base station by using a MAC CE/DCI. Such a MAC CE/DCI is used as a trigger for cell switching. It is assumed that the cell switching is monitored by a specific window/timer. As described above, it is preferable that success/failure of cell switching be notified in some manner (be possible to be recognized by a UE/gNB). For example, the above-described MAC CE is used as a command for cell switching. Accordingly, a timer related to the MAC CE needs to be newly designed/defined.

### {MAC Reconfiguration}

An existing specification defines MAC reconfiguration in cell switching. For example, the following descriptions are listed as operations to be performed by a MAC entity when a higher layer requests reconfiguration of the MAC entity (see TS38.321 5.11): the MAC entity
initializes a corresponding HARQ entity in response to addition of an SCell;
removes the corresponding HARQ entity in response to removal of the SCell;
applies a new value for a timer when the timer is (re) started;
applies a new maximum parameter value when a counter is initialized; and
immediately applies a configuration received from the higher layer for another parameter.

### {MAC Reset}

The existing specification defines MAC reset in cell switching. For example, TS38.321 5.12 lists operations to be performed by the MAC entity under a certain condition (if the higher layer requests reset of the MAC entity, or if reset of the MAC entity is triggered for SCG (secondary cell group) deactivation). Here, description of the respective operations will be omitted. Note that UE operations related to the MAC reset are not limited to the operations defined in the existing specification, and a new operation may be defined in a specification or may be additionally configured/indicated by the higher layer.

Here, a type of the MAC reset will be described. For example, the MAC reset can be classified into one of “full MAC reset,” “non MAC reset,” and “partial MAC reset.”

The full MAC reset may mean that all the configurations/procedures are reset/released/canceled under a MAC entity as a target. In other words, the full MAC reset may mean that all the operations defined in TS38.321 5.12 are performed.

The non MAC reset may mean that none of the operations defined in TS38.321 5.12 are performed, that is, that the UE follows current configuration/procedure under a MAC entity as a target.

For example, the partial MAC reset may mean that at least part of the operations defined in TS38.321 5.12 is performed and that another part of the operations is not performed. The partial MAC reset may mean that part of the operations defined in TS38.321 5.11 is reconfigured and that another part of the operations is not reconfigured. In other words, in the present disclosure, MAC reset and MAC reconfiguration may be interchangeably interpreted.

For the partial MAC reset, the number of UE operations to be applied may be defined stepwise. In other words, a level of the partial MAC reset may be defined based on the number of operations defined in TS38.321 5.12.

For example, when levels of the partial MAC reset are defined by 0 to N (where N is a natural number), level 0 and level N may set the numbers of UE operations to be applied to zero and a maximum number (application of all the operations), respectively. In other words, so as to increase the number of UE operations to be applied as a level of the partial MAC reset increases, the levels may be defined. In this case, level 0 and level N (maximum level) may mean non MAC reset and full MAC reset, respectively. Levels of partial MAC reset are defined in such a manner, thereby enabling a type of MAC reset to be defined stepwise. As a result, suitable UE operations can be applied to different scenarios/candidate cells for cell switching.

The level of the partial MAC reset may be defined not only based on the number of operations defined in TS38.321 5.12, but also based on a type (for example, a level of importance) of the operations.

The level of the partial MAC reset may be configured/indicated from a NW by using RRC signaling/MAC signaling.

In the present disclosure, a type of MAC reset, full MAC reset, non MAC reset, and partial MAC reset may be interchangeably interpreted.

### {Analysis}

For future radio communication systems (for example, Rel. 18 (or later versions)), it is assumed/studied that, in inter-cell mobility (L1/L2 inter cell mobility), a network (for example, RRC signaling/MAC signaling) explicitly controls whether a UE performs the above-described partial MAC reset/full MAC reset, whether the UE re-establishes Radio Link Control (RLC), and whether the UE performs data recovery with Packet Data Convergence Protocol (PDCP).

It is also assumed that a cell as a candidate (candidate cell) for switching/scenario for cell switching differs between cell switchings. For different candidate cells, different scenarios (intra-distribution node (intra-DU (Distribution Unit)) scenario/inter-distribution node (inter-DU) scenario) and different MAC reset operations (“full MAC reset,” “non MAC reset,” and “partial MAC reset” described above) are assumed.

In other words, it is assumed that procedure after reception of a cell switch command (information related to a cell switching indication) (for example, the above-described MAC reset) differs between different scenarios/different candidate cells. Thus, it is assumed that time required for cell switching differs for each scenario/candidate cell. For example, the partial MAC reset may be used to avoid data loss in communication.

Thus, it is assumed that, when candidate cells are configured/applied/supported, inter-cell mobility (for example, switching from a serving cell to a candidate cell (or an additional cell/target cell)) is performed, but studies have not sufficiently been made on how to perform control in such a case. Unless switching between a serving cell and a candidate cell (for example, inter-cell mobility) is performed appropriately, communication quality may deteriorate.

The inventors of the present invention focused on inter-cell mobility (for example, cell switching) in a case where a candidate cell (or additional cell, target cell) is configured/supported, studied appropriate control methods for the inter-cell mobility (in particular, cell switching and operation after cell switching), and came up with the idea of the present embodiment.

Embodiments according to the present disclosure will be described in detail with reference to the drawings as follows. Note that the aspects (for example, cases) below may each be employed individually, or may be employed in combination of at least two.

In the present disclosure, “A/B” and “at least one of A and B” may be interchangeably interpreted. In the present disclosure, “A/B/C” may mean “at least one of A, B, and C.”

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common ICI state, quasi-co-location (QCL), QCL assumption, and the like may be interchangeably interpreted.

A spatial relation information Identifier (ID) (TCI state ID) and spatial relation information (TCI state) may be interchangeably interpreted. “Spatial relation information” may be interchangeably interpreted as “a set of spatial relation information”, “one or a plurality of pieces of spatial relation information”, and the like. The TCI state and the TCI may be interchangeably interpreted.

In the following embodiments, a “plurality of” and “two” may be interchangeably interpreted. A “TAG” and a “TAG ID” may be interchangeably interpreted. A “cell,” a “CC,” and a “carrier” may be interchangeably interpreted.

The following description may be applied in inter-cell mobility (for example, L1/L2 inter cell mobility) or may be applied in communication control other than inter-cell mobility. The L1/L2 inter-cell mobility may be interpreted as at least one of L1/L2 cell switching, cell switching, cell switch, and cell change.

### (Radio Communication Method)

### First Embodiment

A first embodiment relates to introduction of a new window/timer for cell switching.

In the present disclosure, the new window/timer (for example, at least one of a start time (start slot, start symbol, or the like) and a length) may be defined in a specification, or may be configured/indicated for a UE, from a base station, by using an RRC parameter/MAC CE/DCI.

In the present disclosure, the window and the timer may be interchangeably interpreted. In the present disclosure, the new window/timer and a specific window/timer (certain window/timer) may be interchangeably interpreted. In the present disclosure, the new window/timer may mean the same concept as that of the specific window/timer described above.

In the present disclosure, information indicating serving cell change (or change to a candidate cell) (cell switching indication information) may include information related to UE operation (MAC reconfiguration/MAC reset) after cell switching. The information related to the MAC reset may include information related to the type of MAC reset described above (at least one of the full MAC reset, the non MAC reset, and the partial MAC reset) (for example, information related to a level of the partial MAC reset).

A new window/timer may be defined for cell switching. The definition of the new window/timer may be reuse of an existing window/timer. The new window/timer may be a window/timer started when/after an indication of L1/L2 cell switching (cell switch command) is signaled.

If procedure for the cell switching is completed (success of the cell switching) before an end/expiration of the new window/timer (or within a specific window/timer), the new window/timer may be stopped.

If the procedure for the cell switching is not completed (failure of the cell switching) before the end/expiration of the new window/timer (or within the specific window/timer), the UE may return to an original serving cell (which may be referred to as a source cell) before the cell switching, and may apply the last TCI state in the cell and monitor DL transmission (for example, a PDCCH), for example.

The UE may control, based on the new window/timer, UE operation after the cell switching.

Next, configuration of the new window/timer will be described,

### {Option 1-1}

Configuration of a single/common window/timer with a single value may be applied to the UE, for all the candidate cells (or for each UE or for each MAC entity/MCG/SCG). This case enables configuration of the new window/timer to be simplified.

### {Option 1-2}

Configuration of a single/common window/timer may be applied to the UE, for all the candidate cells (or for each UE or for each MAC entity/MCG/SCG). This case enables configuration of the new window/timer to be simplified. As values of the new window/timer, a plurality of variations (not only one value, but also a plurality of values) can be configured. The value of the new window/timer may be determined based on configuration/indication of a MAC reset configuration (full MAC reset/non MAC reset/partial MAC reset described above) and configuration of a cell switch command.

As described above, it is assumed that procedure after reception of a cell switch command (information related to a cell switching indication) (for example, the above-described MAC reset) differs between different scenarios/different candidate cells. Thus, it is assumed that time required for cell switching differs for each scenario/candidate cell. Accordingly, as described above, a different value is configured as a value of the new window/timer for each scenario/candidate cell, thereby enabling UE operation related to cell switching to be flexibly controlled.

### {Option 1-3}

A specific (separate) window/timer configuration may be applied to the UE, for each candidate cell. For example, the candidate cell may consist of one candidate cell set obtained by grouping, based on a certain rule, a plurality of candidate cells together. In other words, a window/timer configuration may be applied to the UE, for each candidate cell set. This case enables UE operation related to cell switching to be flexibly controlled for each candidate cell/candidate cell set. Note that the candidate cell set may be simply referred to as a cell set.

### {Variation 1}

The new window/timer may be supported to be updated/indicated by a NW via RRC/new MAC CE/cell switch command (indicating cell switching) MAC CE.

### {Variation 2}

Two (or three or more) new window/timer configurations/values may be configured for a plurality of candidate cell sets (two candidate cell sets). For example, one certain window/timer configuration/value may be applied to a candidate cell belonging to the same cell set as that for a current SpCell (serving cell). On the other hand, a different (another) window/timer configuration/value may be applied to a candidate cell belonging to a cell set different from that for the current SpCell. When a plurality of cell sets different from the cell set including the current SpCell are present, a separate window/timer configuration/value may be applied for each different cell set.

For example, in a case where the current serving cell is changed (switched), it is assumed that a scenario for a candidate cell (intra-distribution node scenario/inter-distribution node scenario described above) is also changed in response to the cell switching. Even in such a case, UE operation related to cell switching can be flexibly controlled for each scenario/candidate cell.

According to the first embodiment, the new window/timer is defined, thereby enabling UE operation related to cell switching to be appropriately controlled.

### Second Embodiment

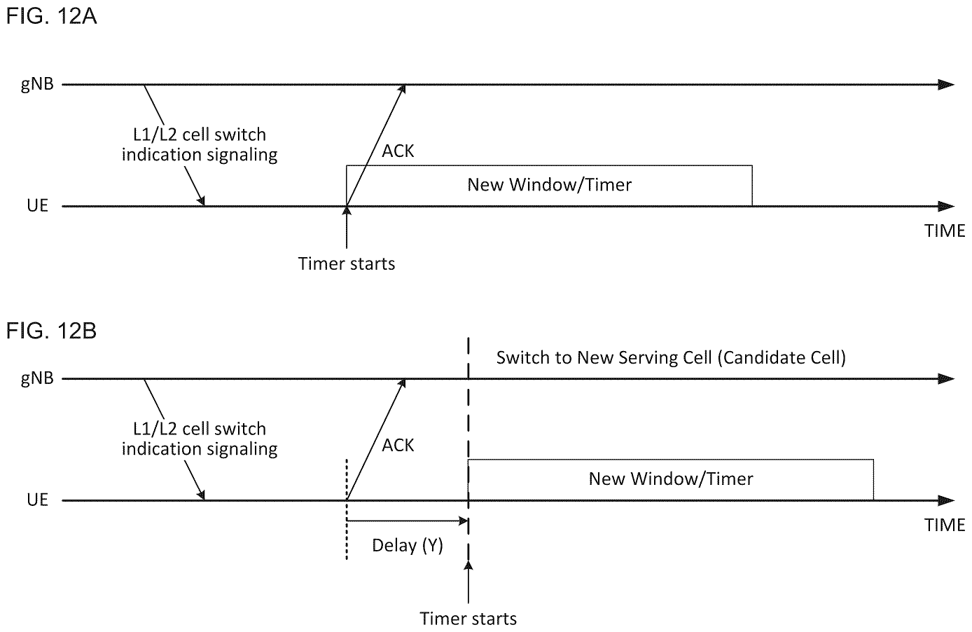

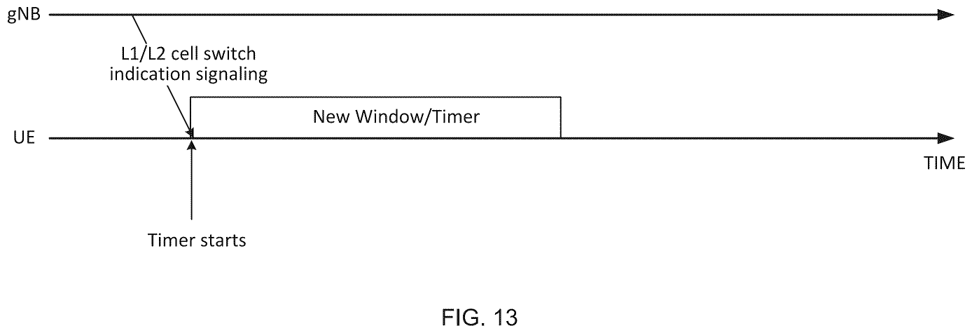

A second embodiment relates to a start (timing) of the new window/timer described above. FIG. 12 is a diagram to show an example of a start timing of the new window/timer according to option 2-1. FIG. 13 is a diagram to show an example of a start timing of the new window/timer according to option 2-2.

### {Option 2-1}

The new window/timer may be started, for example, at one of the following timings (see FIG. 12);
after transmitting a HARQ-ACK (for example, an ACK) for reception of a serving cell switching indication (for example, L1/L2 cell switch command) (see FIG. 12A);
after a lapse of a certain period (for example, Y) from the transmission of the HARQ-ACK (see FIG. 12B); and
after the UE applies serving cell switching to a new target cell after receiving the switching indication.

Note that the start timing of the timer in FIG. 12B may be the same as a timing at which switching to a new serving cell (candidate cell) is applied (see, for example, FIG. 8).

Note that “after the UE applies serving cell switching to a new target cell after receiving the switching indication” described above may be interpreted as “after success of cell switching (see FIGS. 8 and 9)”, and vice versa.

### {Option 2-2}

The new window/timer may be started at a timing of reception of an L1/L2 cell switch command (new MAC CE) (see FIG. 13).

### {Option 2-3}

When the example of the success of cell switching in the aspect of {Option 1A-2} described above is applied, a value of the new window/timer may be determined as follows. Note that values described below are merely examples, and can be changed appropriately (different values may be configured).

For example, assume a case where three values of the new window/timer (X=3, value=30 ms, 80 ms, 150 ms) are configured. Here, X and value indicate the number of values (natural number) and a specific window/timer value, respectively.

When RRC/MAC CE related to a cell switch command indicates, as UE operation after the cell switching, non MAC reset, a value of the new window/timer may be set to 30 ms.

When the RRC/MAC CE related to the cell switch command indicates, as UE operation after the cell switching, partial MAC reset, a value of the new window/timer may be set to 80 ms.

When the RRC/MAC CE related to the cell switch command indicates, as UE operation after the cell switching, full MAC reset, a value of the new window/timer may be set to 150 ms.

To indicate the above respective values, new bit fields (for example, 2 bits) may be added to the cell switch command (for example, a new MAC CE). Specifically, the new bit fields “00,” “01,” and “10” may indicate value=30 ms, value=80 ms, and value=150 ms, respectively. The new bit fields are used in this manner, thereby enabling values of the new window/timer to be appropriately indicated. Note that the above values may be indicated by using existing fields, instead of using the new bit fields.

As described above, when X=3 is defined/configured, three types of applicable MAC reset are present. Specifically, the following three types are applicable: non MAC reset, partial MAC reset, and full MAC reset. In other words, X may indicate the number of applicable MAC resets (number of types).

Here,

### <Case 1>

When the non MAC reset is applied, the smallest value of the three values (minimum value of the three values) may be used for a value of the new window/timer.

### <Case 2>

When the partial MAC reset is applied, the second smallest value of the three values (center value of the three values) may be used for a value of the new window/timer.

### <Case 3>

When the full MAC reset is applied, the third smallest value of the three values (maximum value of the three values) may be used for a value of the new window/timer.

The above values are not limited to X=3, and may correspond to another number. For example, when X<3, a common value may be used in a plurality of cases. Alternatively, one reference value may be predefined, and configuring/indicating an offset value for the reference value may allow different values to be indicated in a plurality of cases. In this case, the reference value/offset value may be predetermined in a specification, or may be configured/indicated by a higher layer.

When X >3, a different value is indicated even in the same case, depending on a condition/scenario/signaling/candidate cell or the like, thereby enabling the new window/timer to be controlled more flexibly.

The above-described association between X and the corresponding values may be associated with the above-described level of the partial MAC reset. In other words, the level of the partial MAC reset may be associated with the number of applicable MAC resets. Furthermore, the association may be defined such that a value of the new window/timer increases in accordance with ascending order of the level of the partial MAC reset. In other words, the value of the new window/timer may increase as the level of the partial MAC reset increases. This is based on the idea that the number of applicable UE operations increases as the level of the partial MAC reset increases, and thus a value (time length) of the new window/timer also increases (is to be increased) in response to the increase.

According to the second embodiment, a new window/timer related to cell switching can be appropriately controlled.

### Third Embodiment

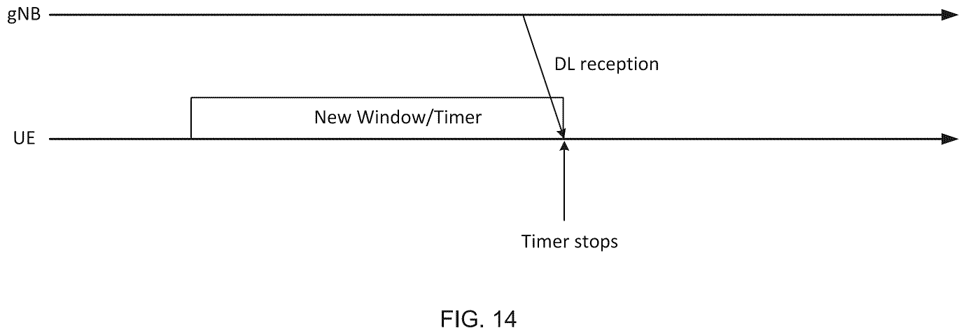

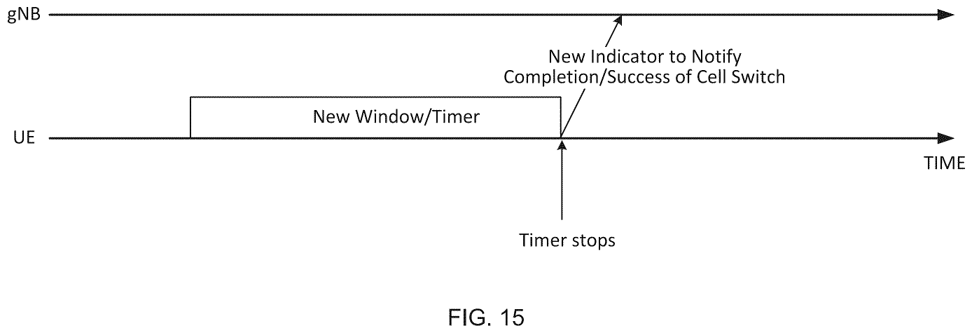

A third embodiment relates to a stop (timing) of the new window/timer described above. FIG. 14 is a diagram to show an example of a stop timing of the new window/timer according to option 3-1. FIG. 15 is a diagram to show an example of a stop timing of the new window/timer according to option 3-2.

### {Option 3-1}

The new window/timer may be stopped, for example, at one of the following timings:
after the UE receives, in the new window/timer, a DL from a new target cell (or a candidate cell to be a change destination) (see FIG. 14); and
after the UE completes, in the new window/timer, random access procedure (or RACH procedure) for a new target cell (or a candidate cell to be a change destination).

Note that the above-described stop timing of the timer may be “after success of cell switching.”

The DL received by the UE described above may be at least one of the DLs described in options 1A-2-1 to 1A-2-3.

### {Option 3-2}

The new window/timer may be stopped after (at a timing when) the UE transmits, to a NW (qNB), a new indicator related to completion/success of cell switching (see FIG. 15). The new indicator may include an indicator that notifies completion/success of cell switching. The new indicator may be a new RRC information element (for example, a parameter related to a cell switch completion message)/new MAC CE/new SR reported from the UE to the NW.

### <Variations>

The UE may not only explicitly notify completion/success of cell switching by using the new indicator as described above, but also use certain UL signaling as an implicit indicator. For example, the UE may implicitly notify the NW of completion/success of cell switching by using a UCI report/SRS transmission for a new target cell.

The timing when the UE transmits the new indicator to the NW may be based on UE implementation, or may be predefined in a specification. The UE may transmit the new indicator to the NW, for example, at the timings listed in option 3-1 described above. Alternatively, the UE may transmit the new indicator to the NW at a timing of completion/success of cell switching, such as after the UE ends operation for partial MAC reset/full MAC reset or after the UE completes RRC connection with a new target cell, for example.

According to the third embodiment, a new window/timer related to cell switching can be appropriately controlled.

### Fourth Embodiment

A fourth embodiment relates to UE operation in (after) expiration of the new window/timer described above.

When the new window/timer expires, the UE may release a target cell configuration (including a PRACH configuration, a DL/UL configuration, and the like).

Whether to release/reset a MAC configuration/RLC configuration/PDCP configuration may depend on a configuration related for a target cell (the related configuration). The related configuration may be notified via RRC signaling or a MAC CE associated with a cell switch command.

If non MAC reset is indicated for the target cell, the UE may not perform, for the target cell after expiration of the new window/timer, any operation associated with MAC reset. This is because a case where the UE returns to an original serving cell (source cell (source SpCell)) means that a current MAC configuration is available.

If full MAC reset is indicated for the target cell, which means that the UE has already applied a new MAC configuration for the target cell, expiration of the new window/timer requires the UE to release/reset all the MAC configurations for the target cell. The same applies to release/reset of the RLC configuration/PDCP configuration.

If partial MAC reset is indicated for the target cell, which means that the UE has already reset part of a new MAC configuration and applied another part of the MAC configuration for the target cell, expiration of the new window/timer requires the UE to release/reset such another part of the MAC configuration applied for the target cell.

When the new window/timer expires, the UE may revert to various UE settings used in the original serving cell (source cell (source SpCell)), and may start, for the serving cell, procedure for connection reestablishment.

According to the fourth embodiment, UE operation after expiration of a new window/timer can be appropriately controlled depending on a type of MAC reset.

### <Supplements>

At least one of the above-described embodiments may be applied only to a UE that has reported specific UE capability or that supports the specific UE capability.

The specific UE capability may indicate at least one of the following:
supporting of specific UE operation (for example, operation related to MAC reset) in a case of success/failure of cell switching;
supporting of a configuration/value of a new window/timer related to cell switching;
supporting of configuration(s)/value(s) of the new window/timer to be applied in common/separately for different scenarios/candidate cells;
supporting of MAC CE-based update for a configuration/value of the new window/timer; and
supporting of reporting of an indicator indicating completion/success of the cell switching.

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured with specific information related to the above-described embodiment by higher layer signaling.

When the UE does not support at least one of the specific UE capabilities above or is not configured with the specific information, operation of Rel. 15/16/17 may be applied, for example.

### SUPPLEMENTARY NOTES

Regarding one embodiment of the present disclosure, the following supplementary notes of the invention will be given.

### Supplementary Note 1

A terminal including:
a receiving section that receives a MAC CE (MAC Control Element) including cell switching indication information on cell switching from a serving cell to a candidate cell; and
a control section that controls, based on the cell switching indication information, a configuration of a window or a timer for switching from the serving cell to the candidate cell, and operation after the cell switching, wherein
the control section controls the window or the timer, based on a MAC reset configuration indicating the operation after the cell switching.

### Supplementary Note 2

The terminal according to supplementary note 1, wherein the window or the timer is started after transmission of an ACK (ACKnowledgement) for the cell switching indication information or after a certain period from the transmission of the ACK.

### Supplementary Note 3

The terminal according to supplementary note 1 or 2, wherein the window or the timer is stopped after success of the cell switching.

### Supplementary Note 4

The terminal according to any one of supplementary notes 1 to 3, wherein the control section controls the operation after the cell switching, based on a type of MAC reset indicated by the MAC reset configuration.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

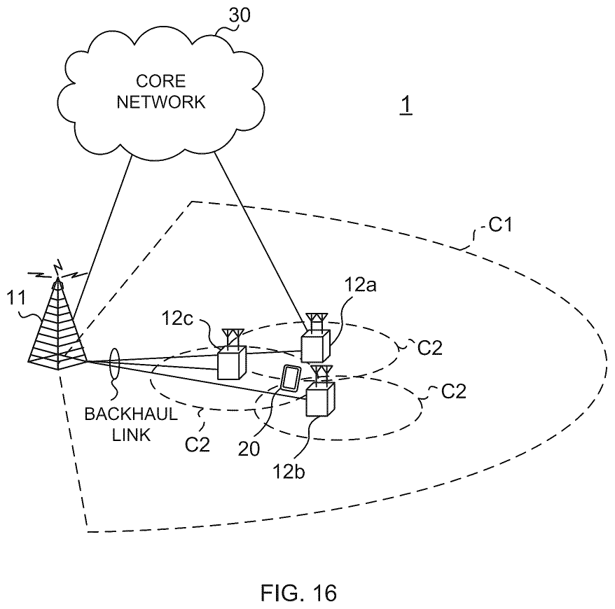

FIG. 16 is a diagram to show an example of a schematic structure of the radio communication system according to one embodiment. The radio communication system 1 (which may be referred to simply as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (qNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (qNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NFs) such as User Plane Function (UPF), Access and Mobility management Function (AMF), Session Management Function (SMF), Unified Data Management (UDM), Application Function (AF), Data Network (DN), Location Management Function (LMF), and operation, administration and maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DET-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated.

In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

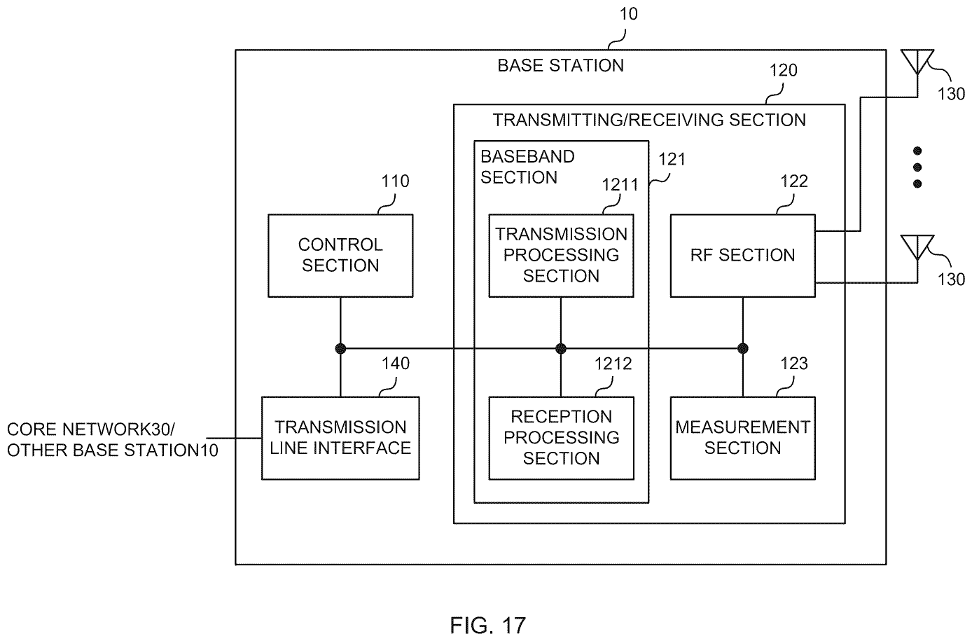

FIG. 17 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RE section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus (for example, a network node that provides an NF) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit, to the terminal, at least one of downlink control information and a MAC CE (MAC Control Element) including cell switching indication information on cell switching from a serving cell to a candidate cell. The control section 110 may judge success or failure of switching from the serving cell to the candidate cell, based on an ACK (ACKnowledgement) for the cell switching indication information transmitted from the terminal. The control section 110 may indicate cell switching operation by using the cell switching indication information. A configuration of a window or a timer for switching from the serving cell to the candidate cell may be controlled based on a MAC reset configuration indicating operation after the cell switching.

### (User Terminal)

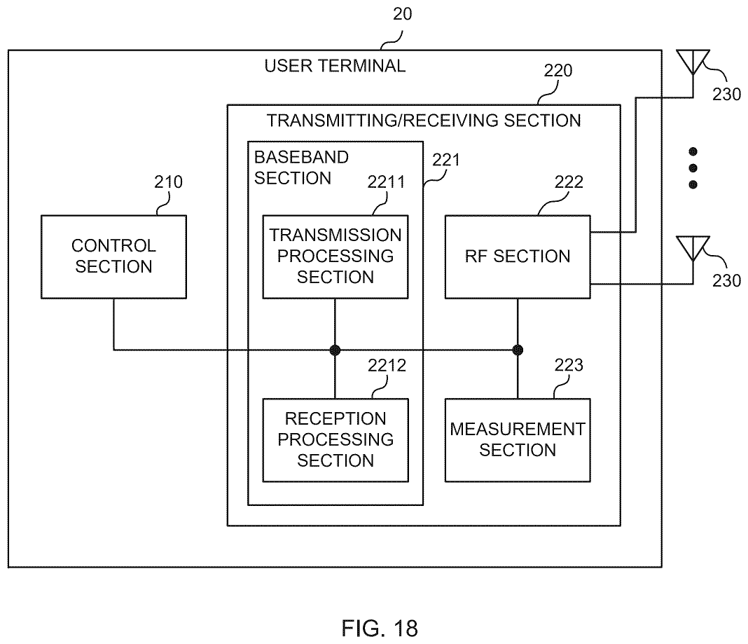

FIG. 18 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212.

The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DET processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DET processing as the above-described transmission processing to transmit the channel by using a DFT-S-OFDM waveform if transform precoding is enabled, and otherwise, does not need to perform the DET processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RIC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive at least one of downlink control information and a MAC CE (MAC Control Element) including cell switching indication information on cell switching from a serving cell to a candidate cell. The control section 210 may judge success or failure of switching from the serving cell to the candidate cell, based on at least one of transmission of an ACK (ACKnowledgement) for the cell switching indication information and reception of a DL transmission from the candidate cell in a period of a specific window or timer after reception of the cell switching indication information. The specific window or timer may be started after transmission of the ACK or after a certain period from the transmission of the ACK. The control section 210 may judge that switching from the serving cell to the candidate cell has failed, in a case of failure to receive a DL transmission from the candidate cell/failure to complete random access procedure in the period of the specific window or timer. When switching from the serving cell to the candidate cell has failed, the control section 210 may perform control so as to perform random access procedure for at least one of the serving cell or the candidate cell.

The control section 210 may control, based on the cell switching indication information, a configuration of a window or a timer for switching from the serving cell to the candidate cell, and operation after the cell switching. The control section 210 may control the window or the timer, based on a MAC reset configuration indicating the operation after the cell switching. The window or the timer may be started after transmission of an ACK (ACKnowledgement) for the cell switching indication information or after a certain period from the transmission of the ACK. The window or the timer may be stopped after success of the cell switching. The control section 210 may control the operation after the cell switching, based on a type of MAC reset indicated by the MAC reset configuration.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

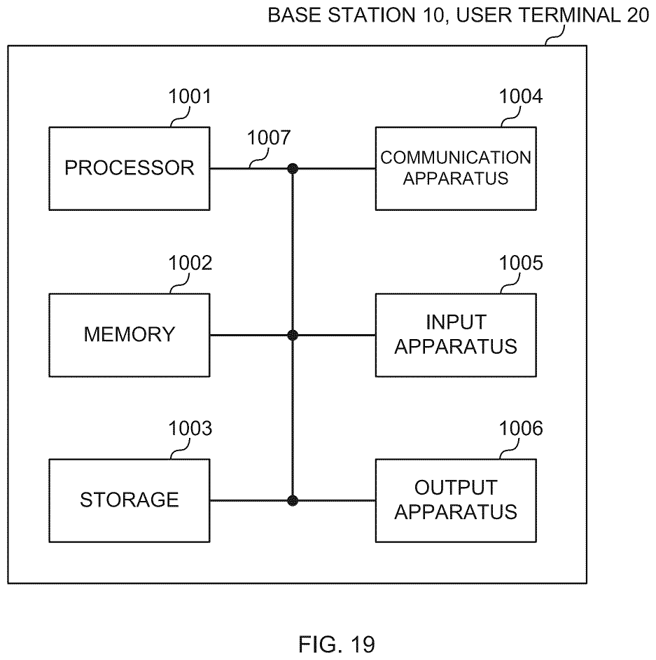

For example, a base station, a user terminal, and so on according to one embodiment of the present disclosure may function as a computer that executes the processes of the radio communication method of the present disclosure. FIG. 19 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### (Variations)

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, plurality of consecutive subframes may be referred to as a “TTI”, or one slot or one mini-slot may be referred to as a “TTI”, In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CES).

Also, notification of certain information (for example, notification of “x”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

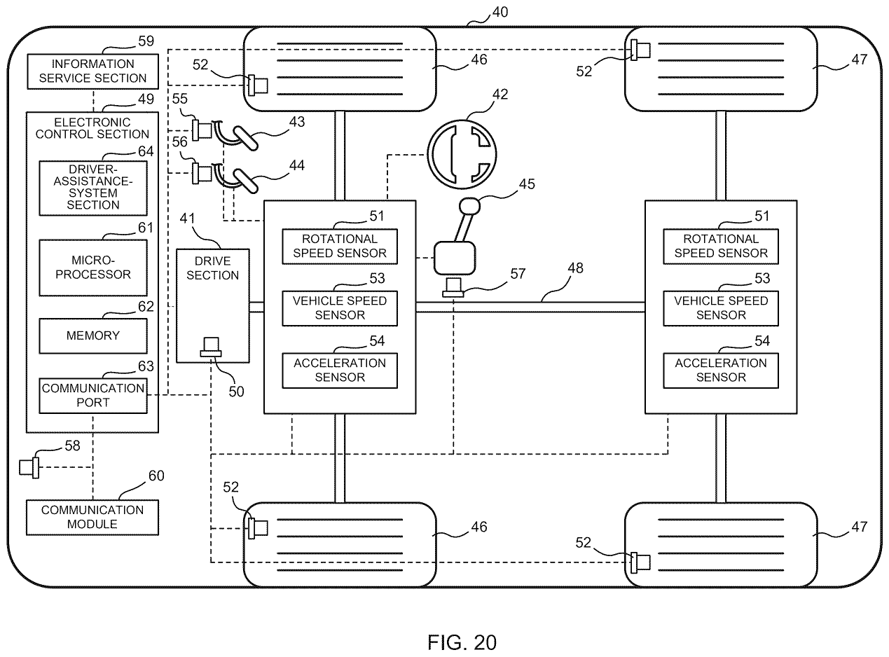

FIG. 20 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

1.-6. (canceled)

7. A terminal comprising:
a receiver that receives a medium access control control element (MAC CE) including information indicating cell switching from a serving cell to a target cell; and
a processor that starts, based on the MAC CE, a timer for cell switching to the target cell and stops the timer based on downlink (DL) reception from the target cell.

8. The terminal according to claim 7, wherein the DL reception is reception of a physical downlink control channel (PDCCH) from the target cell.

9. The terminal according to claim 7, wherein when the timer expires, the processor starts, for the serving cell, a procedure for connection re-establishment.

10. A radio communication method for a terminal, comprising:
receiving a medium access control control element (MAC CE) including information indicating cell switching from a serving cell to a target cell; and
starting, based on the MAC CE, a timer for cell switching to the target cell and stopping the timer based on downlink (DL) reception from the target cell.

11. A base station comprising:
a transmitter that transmits a medium access control control element (MAC CE) including information indicating cell switching from a serving cell to a target cell; and
a processor that indicates, using the MAC CE, cell switching to the target cell,
wherein a timer for cell switching to the target cell is started based on the MAC CE, and is stopped based on downlink (DL) reception from the target cell.

12. A system comprising a terminal and a base station, wherein
the terminal comprises:
a receiver that receives a medium access control control element (MAC CE) including information indicating cell switching from a serving cell to a target cell; and
a processor that starts, based on the MAC CE, a timer for cell switching to the target cell and stops the timer based on downlink (DL) reception from the target cell, and
the base station comprises:
a transmitter that transmits the MAC CE; and
a processor that indicates, using the MAC CE, cell switching to the target cell.
